(19) United States
(12) Patent Application Publication
(10) Pub. No.: US 2020/0035412 A1
(43) Pub. Date: Jan. 30, 2020

(54) METHOD OF CREATING A MAGNET

(71) Applicants: BROWN UNIVERSITY, Providence, RI (US); LAWRENCE LIVERMORE NATIONAL LABORATORY, Livermore, CA (US)

(72) Inventors: Shouheng SUN, East Greenwich, RI (US); Bo SHEN, Providence, RI (US); Adriana MENDOZA-GARCIA, Boston, MA (US); Scott K. MCCALL, Livermore, CA (US); Sarah E. BAKER, Dublin, CA (US)

(21) Appl. No.: 16/500,993

(22) PCT Filed: Apr. 5, 2018
(86) PCT No.: PCT/US2018/026313

§ 371 Date: Oct. 4, 2019

Related U.S. Application Data
(60) Provisional application No. 62/481,901, filed on Apr. 5, 2017.

(51) Int. Cl. H01F 41/02; B22F 1/02; B22F 3/02; C22C 19/07; H01F 1/03; H01F 1/147; H01F 1/057; H01F 1/055

(52) U.S. Cl. CPC H01F 41/0266; B22F 1/02; B22F 3/02; C22C 19/07; H01F 1/0306; C22C 2202/02; H01F 1/057; H01F 1/055; B22F 2302/256; B22F 2301/35; B22F 2301/15; H01F 1/147

(57) ABSTRACT

A method of stabilizing soft particles to create dried nanocomposite magnets includes coating a plurality of soft particles with a layer of SiO₂, the soft particles being nanoparticles, creating a composite by mixing the soft particles with hard phase via a solution phase based assembly, annealing the composite, washing the composite with an alkaline solution to remove SiO₂, and compacting the composite to create dried nanocomposite magnets.

### CROSS REFERENCE TO RELATED APPLICATIONS

This application claims benefit from U.S. Provisional Patent Application Ser. No. 62/481,901, filed Apr. 5, 2017, which is incorporated by reference in its entirety.

### STATEMENT REGARDING GOVERNMENT INTEREST

This invention was made with government support under the Critical Materials Institute, an Energy Innovation Hub funded by the U.S. Department of Energy, Office of Energy Efficiency and Renewable Energy, Advanced Manufacturing Office. The government has certain rights in the invention.

### BACKGROUND OF THE INVENTION

The subject disclosure relates to magnets, and more particularly to a method of creating a magnet.

Magnets are prevalent throughout modern technology. To reduce the volume of magnets and electronic devices, magnets with high densities of magnetic energy are required for highly efficient energy conversions. Further, the magnets require a large magnetic coercively and a remanent magnetization value giving the optimum energy product, (BH)ₘₐₓ. Conventional hard magnets, especially those based on SmCo alloys, can have the largest coercivity, but low magnetization values. To increase magnetization values without sacrificing the coercivity, attempts have been made to couple the hard magnet with a soft magnetic soft phase with a high magnetization value. However, conventional methods of forming hard-soft exchange coupling systems are unable to preserve the size of the soft phase. Rather, the processes tend to fuse the soft phase with the hard phases, forming the undesired alloys and lowering magnetic performance.

More specifically, embedding a nanoscale soft magnetic phase into a hard magnetic matrix is a difficult step in developing exchange-spring nanocomposites with optimum energy product. Such nanocomposites, once prepared properly, can show magnetic performances that are superior to the corresponding single component hard magnets and can serve as a new class of super strong magnets for applications in magnetic device miniaturization and in efficient energy conversions. Conventional high performance permanent magnets are made of rare-earth metal-based alloys of NdFeB or SmCo, among which SmCo, especially the hcp-SmCo₅ alloy, magnets are an important class of magnets used for high temperature applications due to their intrinsic high Currie temperatures (from 400 to 800° C.) and large magnetocrystalline anisotropy constant (up to Ku=2×10⁸ erg cm⁻³ for the SmCo₅). However, the SmCo₅ magnets have low magnetization (“M”) values, limiting the energy density (often measured by energy product, (BH)ₘₐₓ) they can store. SmCo magnet performance can be enhanced by increasing the M value of the magnet by incorporating a high M soft phase in the SmCo matrix, forming exchange-coupled nanocomposites. This has led to the development of various methods to prepare such magnetic nanocomposites, including melt-spun for ribbons, mechanical ball-milling for powder, and sputtering for thin films. To better control the size of the soft phase in the composite structure, chemical synthesis methods are also tested. Despite these efforts, it is still extremely difficult to maintain the size of the soft phase in the composites due to the harsh reductive annealing conditions required for the formation of SmCo₅ alloy structure. This annealing often induces an uncontrolled diffusion of the soft phase into the hard phase, forming an alloy structure and destroying the desired exchange-coupling. Therefore there is a need for a new method to produce SmCo—Fe nanocomposites with uniform nanoscale Fe control so that Fe-size dependent exchange coupling can be studied and the right combination of hard-soft phases can be optimized to obtain the maximum energy product.

### SUMMARY OF THE INVENTION

The following presents a simplified summary of the innovation in order to provide a basic understanding of some aspects of the invention. This summary is not an extensive overview of the invention. It is intended to neither identify key or critical elements of the invention nor delineate the scope of the invention. Its sole purpose is to present some concepts of the invention in a simplified form as a prelude to the more detailed description that is presented later.

In one aspect, the invention features a method of stabilizing soft particles to create dried nanocomposite magnets including coating a plurality of soft particles with a layer of SiO₂, the soft particles being nanoparticles, creating a composite by mixing the soft particles with hard phase via a solution phase based assembly, annealing the composite, washing the composite with an alkaline solution to remove SiO₂, and compacting the composite to create dried nanocomposite magnets.

In another aspect, the invention features a method of stabilizing soft particles for generating a nanocomposite for a magnet including assembling a pre-synthesized Fe nanoparticles which are coated with SiO₂ (silica) and Fe/SiO₂ nanoparticles with Sm—Co—OH to form a SmCo—OH and Fe/SiO₂ mixture, obtaining SmCo5-Fe/SiO₂ composites by annealing the mixture at 850° C. in the presence of Ca, and washing the composites with NaOH/water and conducting a warm compaction to produce exchange coupled SmCo5-Fe nanocomposites with Fe NPs controlled at 12 nm to stabilize a soft magnetic phase in a hard magnetic matrix with enhanced magnetic performance.

In still another aspect, the invention features a method including stabilizing Fe nanoparticles in high temperature annealing conditions for a preparation of exchange-coupled SmCo5-Fe nanocomposites.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF THE DRAWINGS

These and other features, aspects, and advantages of the present invention will become better understood with reference to the following description, appended claims, and accompanying drawings where:

FIG. 1 is an exemplary schematic view of the synthesis of SmCo5-Fe nanocomposites in accordance with the subject technology.

FIG. 2a is a transmission electron microscopy (“TEM”) image of as-synthesized 12 nm Fe NPs in accordance with the subject technology.

FIG. 2b is a TEM image of 12 nm a Fe core with a 7 nm silica shell in accordance with the subject technology.

FIG. 2c is an X-ray diffraction pattern (“XRD”) of 12 nm Fe NPs in accordance with the subject technology.

FIG. 3a is a TEM image of a mixture of as-synthesized Sm(OH)3 and Co(OH)2 in accordance with the subject technology.

FIG. 3b is an XRD pattern of the mixture shown in FIG. 3a.

FIG. 4 is XRD patterns of different SmCo5-Fe composites prepared from reductive annealing.

FIG. 5a is a high angle annular dark field scanning TEM (“HAADF-STEM”) image characterizing the morphology of the Fe NPs in an SmCo—Fe composite.

FIG. 5b illustrates elemental mapping of the SmCo5-Fe composite.

FIG. 6a illustrates hysteresis loops of nanocomposites of SmCo5+x wt. % Fe (where x=0-20) with different content of soft phase at 300K.

FIG. 6b illustrates the change of He and Ms with respect to the nanocomposites of FIG. 6a.

FIG. 6c illustrates the change of (BH)max with the Fe NPs content with respect to the nanocomposites of FIG. 6a.

FIG. 7 illustrates hysteresis loops of the nanocomposites of SmCo5+10 wt. % Fe before and after a 1.5 GPa press at 300K.

### DETAILED DESCRIPTION

The subject innovation is now described with reference to the drawings, wherein like reference numerals are used to refer to like elements throughout. In the following description, for purposes of explanation, numerous specific details are set forth in order to provide a thorough understanding of the present invention. It may be evident, however, that the present invention may be practiced without these specific details. In other instances, well-known structures and devices are shown in block diagram form in order to facilitate describing the present invention.

As used herein, the terms “soft particles”, “soft phase”, or “soft phase particles” are used interchangeably to denote soft particles such as Fe, Co, FeCo, combinations thereof, or elements/compounds with similar properties. Further, the terms “hard particles”, “hard phase”, or “hard phase particles” are used interchangeably to denote hard particles such as SmCo or NdFeB based alloys such as SmCo—O, NdFeN—O, SmCo NdFeB, or compounds/alloys having like properties.

In an embodiment, the subject technology relates to a reliable chemical process of stabilizing Fe nanoparticles (“NPs”) in high temperature annealing conditions for the preparation of exchange-coupled SmCo₅—Fe nanocomposites. An SiO₂ coating is used to stabilize the pre-synthesized Fe NPs. Once Fe/SiO₂ is mixed with SmCo—OH and annealed at 850° C. in the presence of Ca and KCl, the SmCo₅—Fe/SiO₂, composites are obtained. The SiO₂ coating can be removed by immersing the SmCo₅—Fe/SiO₂ composite in 10 NaOH, followed by water and ethanol washing. The SmCo₅—Fe powder show a two-phase behavior due to the loosening packing of SmCo₅ and Fe NPs. After warm compaction at room temperature at 1.5 GPa, the composite pellets show a single-phase behavior, indicating the close contact and exchange-coupling of SmCo₅ and Fe NPs. In such a way, 2 nm Fe NPs are stabilized in the —Fe nanocomposites. This can be extended to the preparations of SmCo-M or NdFeB-M (M=Fe, Co, or FeCo) with tunable magnetic properties for permanent magnetic applications.

More generally, the subject technology relates to a new strategy of stabilizing soft particles for generating a nanocomposite for a magnet. For example, in one embodiment of a method of the subject technology, Fe nanoparticles are stabilized in the preparation of SmCo₅-Fe nanocomposites. Pre-synthesized Fe NPs which are coated with SiO₂ (silica) and Fe/SiO₂ NPs are assembled with Sm—Co—OH to form SmCo—OH and Fe/SiO₂ mixture. This mixture is annealed at 850° C. in the presence of Ca and SmCo₅—Fe/SiO₂ composites are obtained. The composites are then washed with NaOH/water, and warm compaction is conducted. In this way, exchange coupled SmCo₅—Fe nanocomposites with Fe NPs controlled at 12 nm are produced. The method serves, in accordance with the subject technology, to stabilize soft magnetic phase in a hard magnetic matrix with enhanced magnetic performance.

In prior methods for the synthesis of nanocomposites, one barrier to success lay in the stabilization of nanoscale Fe, or Fe NPs, in the high temperature SmCo preparation condition. In the earlier tests of stabilizing FePt NPs in the high temperature annealing condition for their structure transformation from magnetically soft Al—FePt to magnetically hard L10-FePt NPs, a robust inorganic coating layer, such as MgO or SiO₂, has been applied to stabilize FePt NPs against sintering at temperatures as high as 800° C. MgO is removed by acid washing while SiO2 is dissolved with a base to give well-dispersed L10-FePt NPs. We tested the MgO coating and found the MgO could also help to stabilize Fe NPs at high temperatures, however, the acid washing process was incompatible with the condition used to stabilize Fe NPs. We then studied the SiO₂ coating, and found that this SiO₂ coating could indeed help to stabilize Fe NPs even in the reductive conversion of SmCo—OH to SmCo. Therefore we developed a new chemical approach to SmCo₅—Fe nanocomposites with controlled Fe NP size.

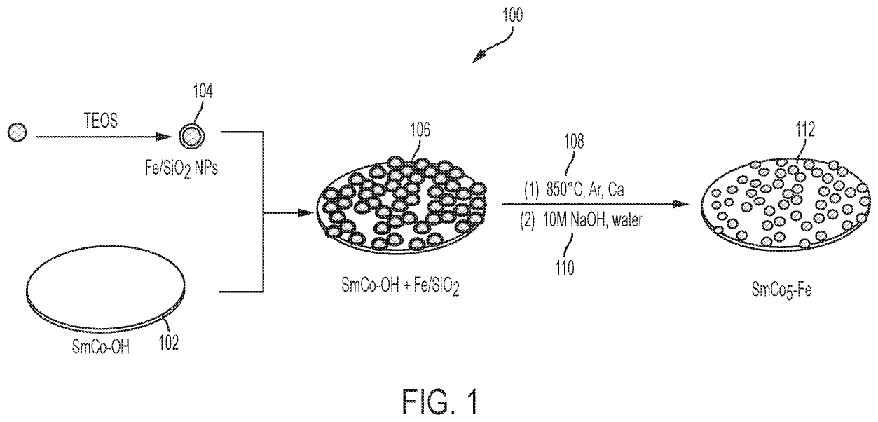

Referring now to FIG. 1, an exemplary synthesis process 100 involves the co-precipitation of SmCo—OH 102 in the presence of Fe/SiO₂ 104. The composite 106 is then subject to an 850° C. annealing in the presence of calcium at 108, after which the SmCo—OH 102 is reduced to SmCo5. Then the mixture is then washed with an alkaline solution to remove SiO₂ at 110 to obtain the desired SmCo5-Fe nanocomposites 112.

For the SmCo₅, its single domain size is substantially 100-300 nm and domain wall width is substantially 6-7 nm. For effective exchange coupling, the soft phase below 15 nm should have good exchange coupling with SmCo₅ hard phase. For example, for the hard-soft composites to show efficient coupling, the soft phase can be twice of the domain wall width of the hard phase, which renders the soft phases to nanometer scale. In example synthetic process, we chose monodisperse 12 nm Fe NPs as an example of the soft phase to demonstrate the new strategy of forming SmCo₅—Fe with Fe being in 12 nm. We prepared the Fe NPs by the decomposition of Fe(CO)₅ in the presence of oleyamine and hexadecylammoniurn chloride (HDA.HC1) at 180° C.

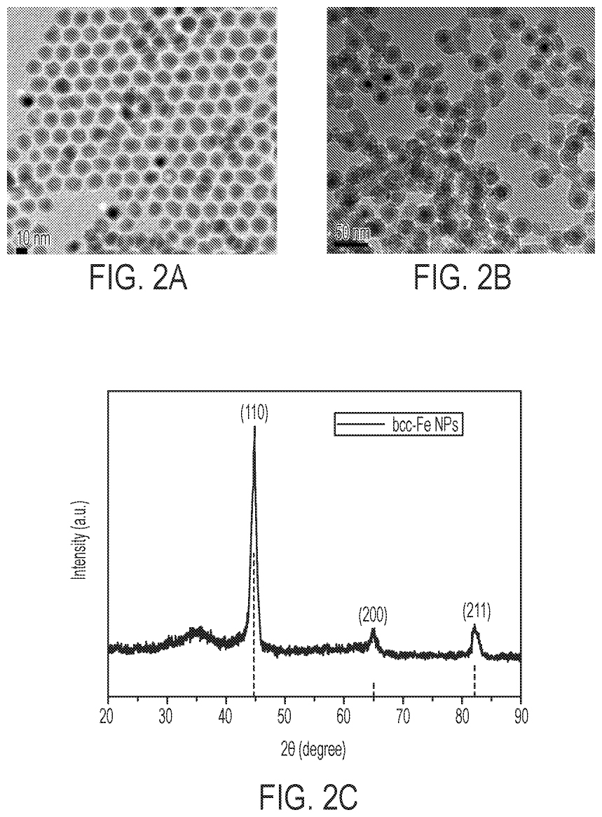

Referring now to FIG. 2a, a transmission electron microscopy (TEM) image of the 12 nm Fe NPs is shown generally at 200. Due to the natural oxidation, the thin layer of Fe₃O₄ can also be seen, which is similar to what is reported. The Fe NPs have a crystalline bcc-structure, as shown in the X-ray diffraction (“XRD”) pattern of the NP sample shown in FIG. 2c.

The Fe phase matches well with the standard bcc pattern of Fe. The Fe NPs with SiO₂ was coated by controlled hydrolysis and condensation of tetraethyl orthosilicate (TEOS) in the presence of Fe NPs. In this coating process, 20 mg Fe NPs were firstly dissolved in a mixing solution of 40 ml cyclohexane and 1 ml polyoxyethylene(5)nonylphenyl ether (Igepal CO-520). Sequentially, 0.4 ml TEOS was added in the solution followed by an injection of 0.4 nil 28% ammonia solution. TEOS was hydrolyzed around Fe NPs in the presence of ammonia to form a uniform SiO₂ coating shell around each Fe NP. FIG. 2b shows a TEM image of core/shell-structured Fe/SiO₂ NPs with a shell thickness of 7 nm.

To embed monodisperse Fe NPs into the SmCos matrix, as described herein, we must first prepare the SmCos. The direct synthesis of SmCo using organic-based chemical protocols is challenging. It is difficult to obtain metallic alloys from the simultaneous and homogeneous reduction of Co²⁺ and Sm³⁺ in solution due to the huge reduction potential difference between Co(II) (−0.28 V) and Sm(III) (−2.30 V), as well as the NP instability against oxidation. Therefore, nanostructured SmCos can be synthesized by reductive annealing of SmCo-oxide precursors at high temperature, similar to the commercial fabrication of SmCo magnets by high temperature reduction of Sm-oxide and Co-oxide by CaH2.

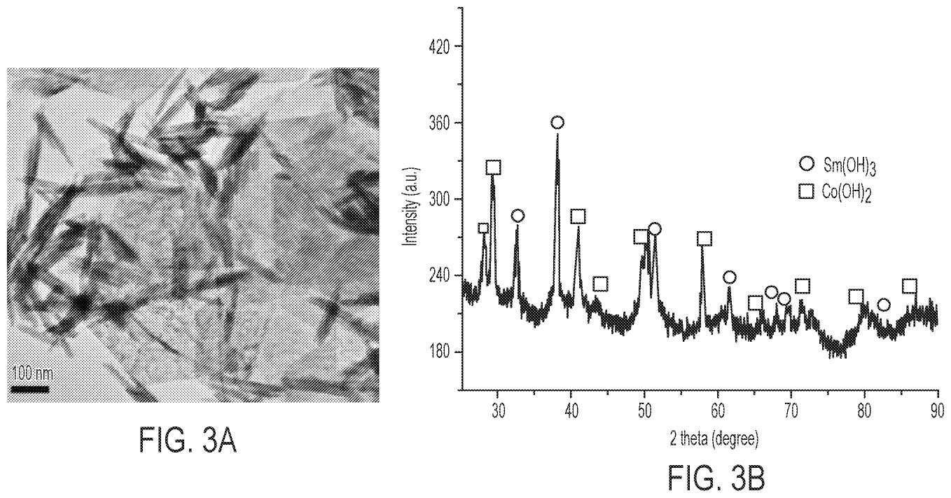

In the present example, we first precipitated aqueous solution of SmCl₃ and CoCl₂ by adding 5 M KOH at 100° C. drop-wise. After leaving the reaction to reflux for 5 hours, the solution was cooled down to room temperature and brownish precipitation was collected by centrifugation. Referring now to FIG. 3a, a TEM image shows the product consists of two kinds of NPs: hexagonal Co(OH)₂ nanoplates (plate-like) and Sm(OH)₃ nanoneedles (needlelike). Referring now to FIG. 3, XRD analysis confirms that the precipitate contains the mixture of Sm(OH)₃ and Co(OH)₂.

Referring again to FIG. 1, to obtain the SmCo—Fe composite 112, SmCo—OH 102 and Fe/SiO₂ 104 were mixed together in ethanol under sonication to form a composite assembly 106. After separation from solution, the powder was ground with Ca and annealed at 850° C. for 30 min under Ar atmosphere at 108. Once cooled to room temperature, the powder was washed with distilled water under argon to dissolve CaO and any unreacted reactants 110. Then the powder was immersed in 10 M KOH solution under sonication, that was pre-heated to 60° C. to remove residual SiO₂ in the composite 106. The powder can be further washed with water and ethanol and dried under vacuum at room temperature. The Sm/Co/Fe composition in the composite was analyzed by inductively coupled plasma-atomic emission spectroscopy. SmCo5 was obtained from the 1/4 Sm/Co precursors. This ratio was slightly reduced from the starting particles, indicating a small amount of Sm lost during the annealing and/or subsequent washing processes. The Fe composition was carried over to the final product.

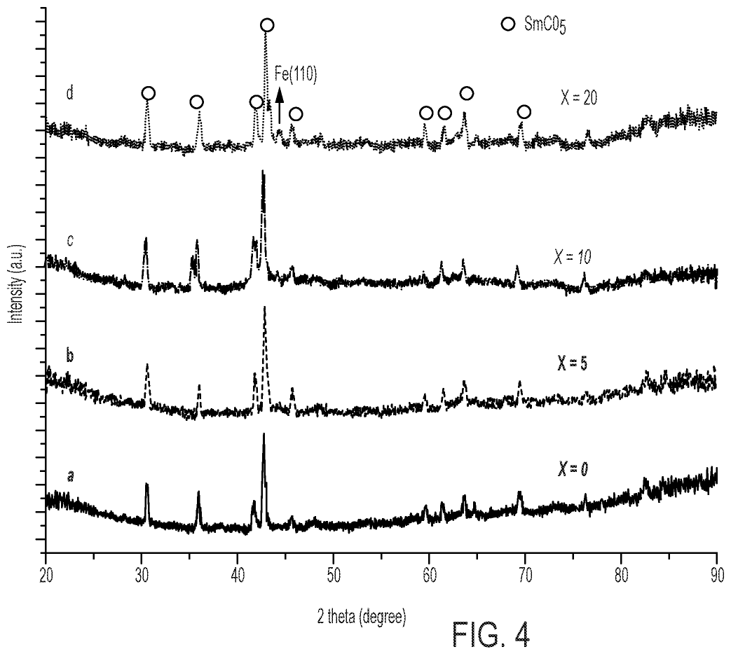

Referring now to FIG. 4, the XRD patterns of different SmCo5-Fe composites prepared from the reductive annealing are shown. The patterns relate to SmCo₅+x wt. % Fe composites where x is equal to the following: (a) x=0; (b) x=5; (c) x=10; and (d)=20. The crystal structure of the SmCo can be indexed with the standard hcp-SmCo5. The more important part is that the bee-Fe NP structure is preserved and the relative intensity of the characteristic bcc-Fe peaks increases with increasing Fe content in the composites, which indicates that Fe NPs survive in the annealing procedure without obvious sign of diffusion into SmCo5 phase.

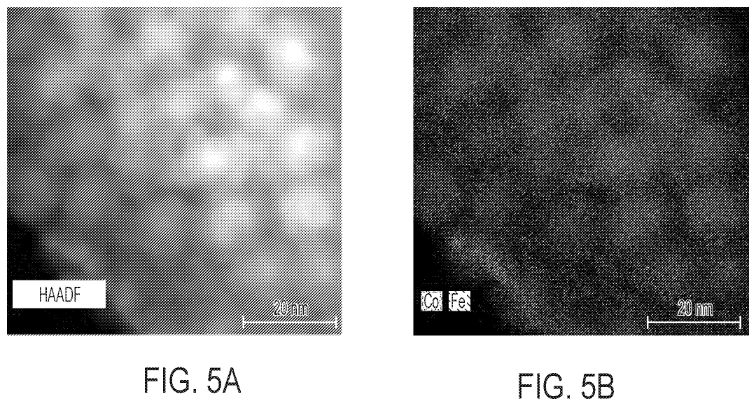

Referring now to FIG. 5a, as shown, the morphology of the Fe NPs in the SmCo—Fe composite was further characterized by high angle annular dark field scanning TEM (“HAADF-STEM”) analysis with the brighter particles embedded inside the relatively dark background. Referring now to FIG. 5b, EDX elemental mapping shows the circles with an average size of 12-13 nm represent Fe NPs and rectangular parts represent SmCo5 matrix. Both RD and EM analyses show that after annealing, Fe NPs were intact with the original size and morphology and there is no obvious aggregation/sintering.

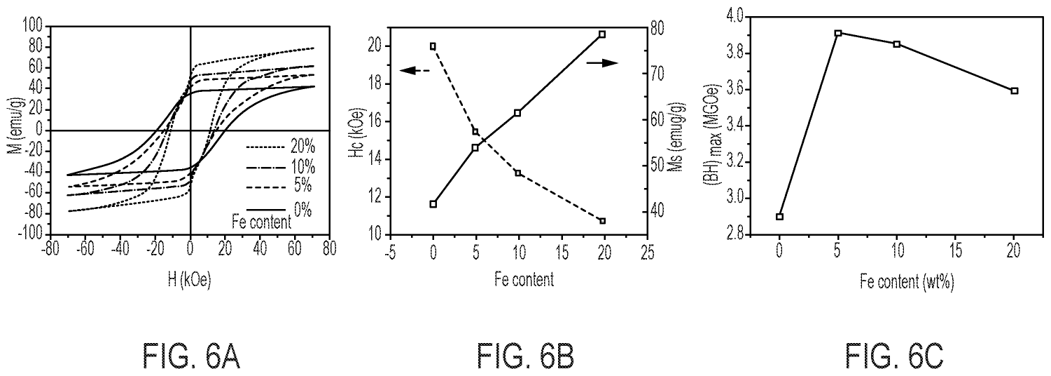

Referring now to FIGS. 6a-6c, magnetic properties of SmCo5-Fe composites were measured by the Physical Property Measurement System (PPMS) under 7 T field. FIG. 6a shows room temperature magnetic hysteresis loops of SmCo₅—Fe composite nanoparticles with different soft phase ratios. This shows that SmCo₅—Fe nanocomposites are ferromagnetic at room temperature. Therefore incorporation of Fe particles into the SmCo₅ matrix changes both coercivity (He) and saturation magnetization (Ms) of the composites (See FIG. 6b). Ms monotonically increases from 42.5 emu/g for only SmCo₅ to 77.6 emu/g for the SmCo₅+20 wt. % Fe nanocomposite, while He decreases from 20.1 to 11.2 kOe. When the Fe content is below 10 wt. %, the composites show single-phase smooth loops, indicating that the soft and hard phases are effectively exchange coupled. However, when Fe content is above 10 wt. %, a kink is seen on the demagnetization curve, indicating a certain degree of decoupling between two phases.

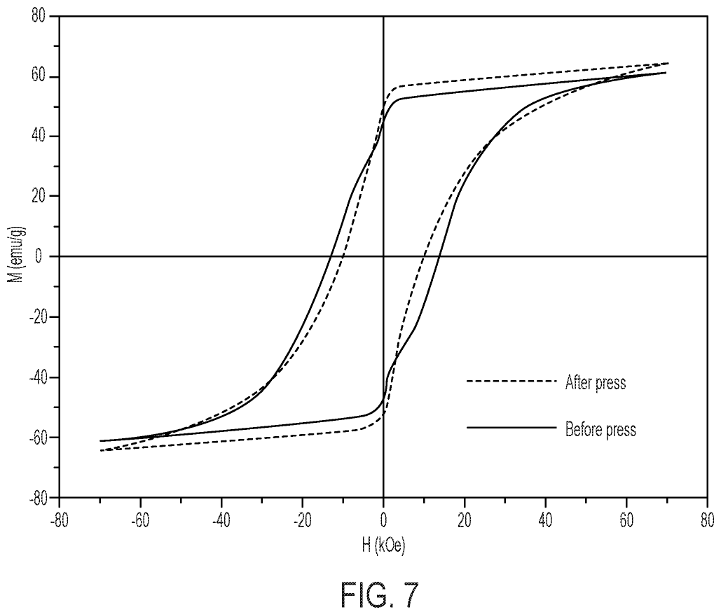

In the embodiment described, to ensure the SmCo₂ and Fe NPs are in tight contact we compacted the powders. Temperature and pressure-holding time during the procedure can have an impact on the success of the procedure. A long holding time may cause the formation of graded interface, which is good for exchange-coupling. On the other hand, high temperature may lead to grain growth so our compaction was conducted at room temperature. Referring now to FIG. 7, the magnetic properties change of SmCo₅+10 wt. % Fe under 1.5 GPa pressure for 24 hours are shown. After compaction, the nanocomposite shows single-phase magnetic behavior. The Ms increases from 61.5 emulg to 63.9 emu/g and He decease from 13.2 kOe to 10.5 kOe. SmCo5+20 wt. % Fe nanocomposite was also pressed at the same condition. After compaction, the hysteresis loop also displays one-phase behavior. Our work related to the subject technology shows that SmCe5-Fe nanocomposite with Fe being 12 nm NPs, exchange-coupling can be established by warm compaction and magnetic properties of the nanocomposites can be tuned by the wt % of Fe NPs.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method of stabilizing soft particles to create dried nanocomposite magnets comprising:
coating a plurality of soft particles with a layer of SiO₂, the soft particles being nanoparticles;
creating a composite by mixing the soft particles with hard phase via a solution phase based assembly;
annealing the composite;
washing the composite with an alkaline solution to remove SiO₂; and
compacting the composite to create dried nanocomposite magnets.

2. The method of claim 1 wherein the soft particles include at least one of the following: Fe, Co, and FeCo.

3. The method of claim 1 wherein the hard phase includes at least one of the following:
SmCo based compound; or NdFeB based compound.

4. The method of claim 1 wherein the hard phase includes at least one of the following:
SmCo—O; NdFeN-0; SmCo metal alloy; or NdFeB metal alloy.

5. The method of claim 1 wherein the step of annealing the composite includes mixing the nanocomposites with Ca in a reducing atmosphere.

6. The method of claim 4 wherein the reducing atmosphere includes Argon and 4% hydrogen.

7. The method of claim 1 wherein the step of annealing the composite is done at substantially 850 degrees Celsius.

8. The method of claim 1 wherein the alkaline solution is an aqueous solution of NaOH or KOH.

9. The method of claim 1 wherein the solution phase based assembly includes SiO₂ coated hard magnetic particles.

10. A method of stabilizing soft particles for generating a nanocomposite for a magnet comprises:
assembling a pre-synthesized Fe nanoparticles which are coated with SiO₂ (silica) and Fe/SiO₂ nanoparticles with Sm—Co—OH to form a SmCo—OH and Fe/SiO₂ mixture;
obtaining SmCo5-Fe/SiO₂ composites by annealing the mixture at 850° C. in the presence of Ca; and
washing the composites with NaOH/water and conducting a warm compaction to produce exchange coupled SmCo5-Fe nanocomposites with Fe NPs controlled at 12 nm to stabilize a soft magnetic phase in a hard magnetic matrix with enhanced magnetic performance.

11. A method comprising:
stabilizing Fe nanoparticles in high temperature annealing conditions for a preparation of exchange-coupled SmCo5-Fe nanocomposites.

12. The method of claim 11 wherein stabilizing comprises:
stabilizing pre-synthesized Fe nanoparticles using a SiO₂ coating;
obtaining composites once Fe/SiO₂ is mixed with SmCo—OH and annealed at 850° C. in the presence of Ca and KCl;
removing the SiO₂ coating by immersing the SmCo5-Fe/SiO₂ composite in NaOH, followed by water and ethanol washing; and
warmly compacting the composite pellets at room temperature at 1.5 GPa.
